(19) United States
(12) Patent Application Publication
(10) Pub. No.: US 2026/0086538 A1
(43) Pub. Date: Mar. 26, 2026

(54) DETECTION AND PREVENTION OF EQUIPMENT FAILURE USING A PLURALITY OF AGENTS

(71) Applicant: MaintainX Inc., Miami, FL (US)

(72) Inventors: Stefan Cristian Turlica, Miami, FL (US); Hugo Dozois-Caouette, Miami, FL (US); Mathieu Marengère-Gosselin, Montreal (CA)

(21) Appl. No.: 19/259,319

(22) Filed: Jul. 3, 2025

Related U.S. Application Data
(60) Provisional application No. 63/667,946, filed on Jul. 5, 2024.

(51) Int. Cl. G05B 19/418; G05B 19/05

(52) U.S. Cl. CPC G05B 19/4184; G05B 19/058

(57) ABSTRACT

In various embodiments, a system for detecting and preventing equipment failure using a plurality of agents includes an interface configured to receive information about a state of the equipment from a plurality of sources. The system includes a data pool including the information from the interface. The system further includes a plurality of agents configured to access data in the data pool, where the plurality of agents are trained to assess a condition of the equipment based on the data. The system includes an orchestrator configured to: evaluate an assessment of a first agent; access the second agent for further assessment in response to the evaluation of the assessment of the first agent indicating access of a second agent; and cause a modification to be made to the equipment.

### CROSS REFERENCE TO OTHER APPLICATIONS

This application claims priority to U.S. Provisional Patent Application No. 63/667,946 entitled DETECTION AND PREVENTION OF EQUIPMENT FAILURE USING OPERATIONAL DATA filed Jul. 5, 2024 which is incorporated herein by reference for all purposes.

### BACKGROUND OF THE INVENTION

Many industries, such as the manufacturing industry, rely on different assets (e.g., units of equipment) to operate. As various examples, these units may include conveyor belts, climate control systems (e.g., HVAC), pressurized equipment, and so on. It is often mission critical for consumers that their equipment operates correctly, predictably, and safely. Conventionally, equipment is monitored by humans. For example, a vibration analyst may visit a worksite periodically (e.g., every 3 months) to survey the vibration patterns of the equipment to determine whether the equipment has failed or may fail in the near future. This is inefficient because of the limits of available human resources. Thus, there is a need for improved detection and prevention of equipment failure.

### BRIEF DESCRIPTION OF THE DRA WINGS

Various embodiments of the invention are disclosed in the following detailed description and the accompanying drawings.

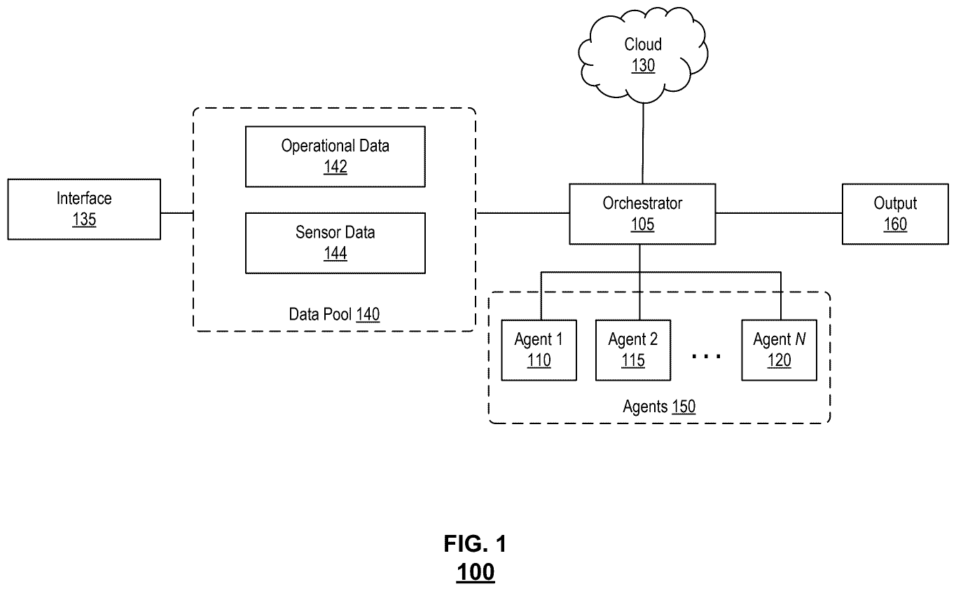

FIG. 1 is a block diagram illustrating an embodiment of a system for detection and prevention of equipment failure using operational data.

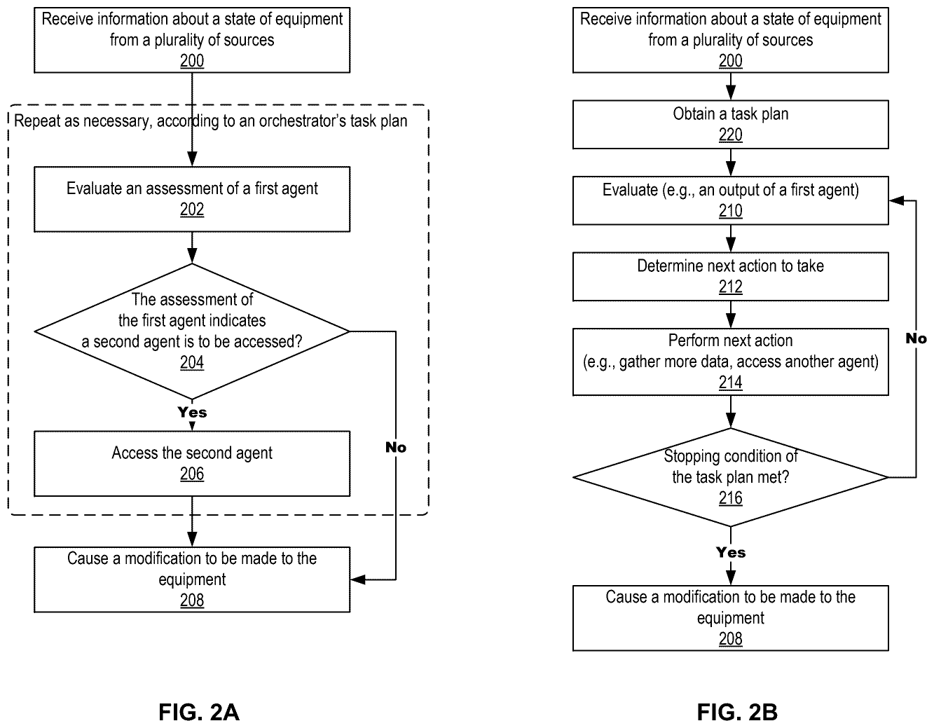

FIG. 2A is a flow diagram illustrating an embodiment of a process for detection and prevention of equipment failure using operational data.

FIG. 2B is a flow diagram illustrating an embodiment of a process for detection and prevention of equipment failure using operational data.

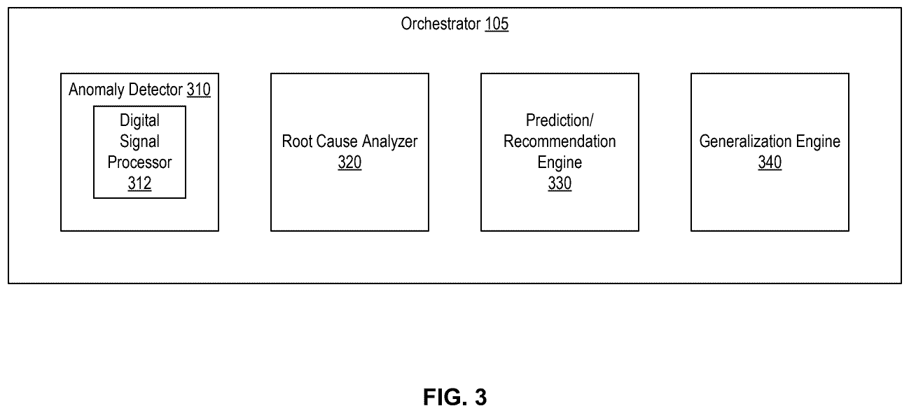

FIG. 3 is a block diagram illustrating an embodiment of a system for detection and prevention of equipment failure using operational data.

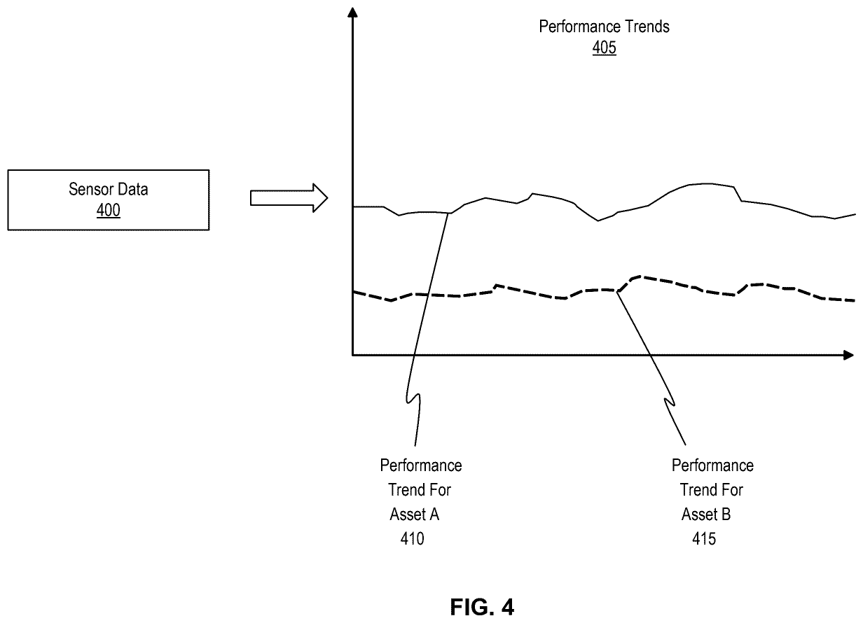

FIG. 4 shows sensor data, which is representative of the sensor data.

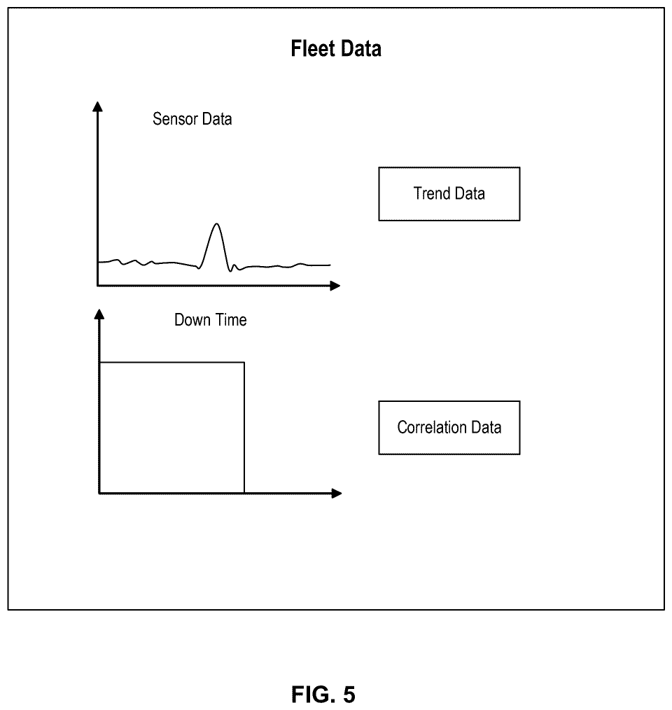

FIG. 5 shows an example of correlations and predictions generated based on that data.

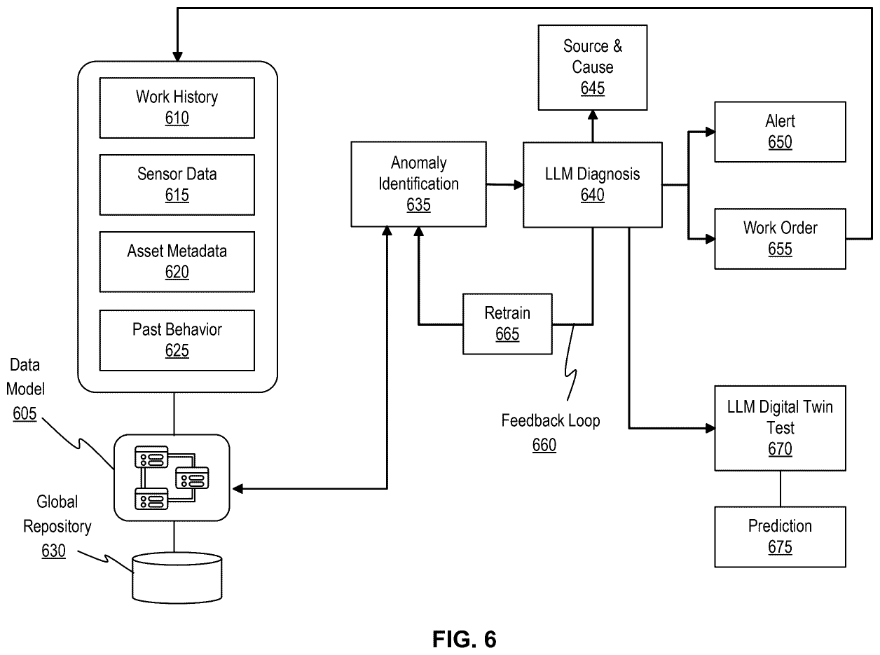

FIG. 6 shows an example of anomaly detection process flow.

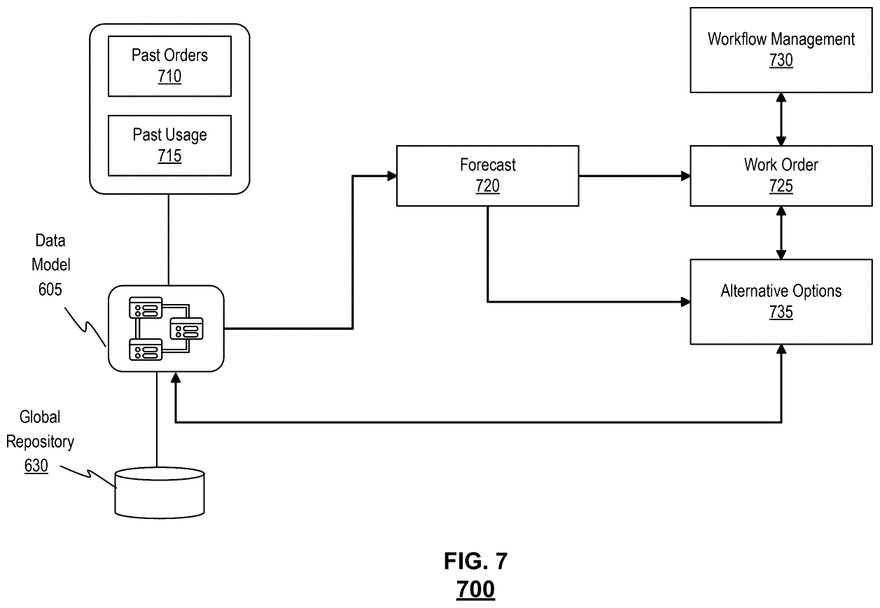

FIG. 7 shows an example of forecasting process flow.

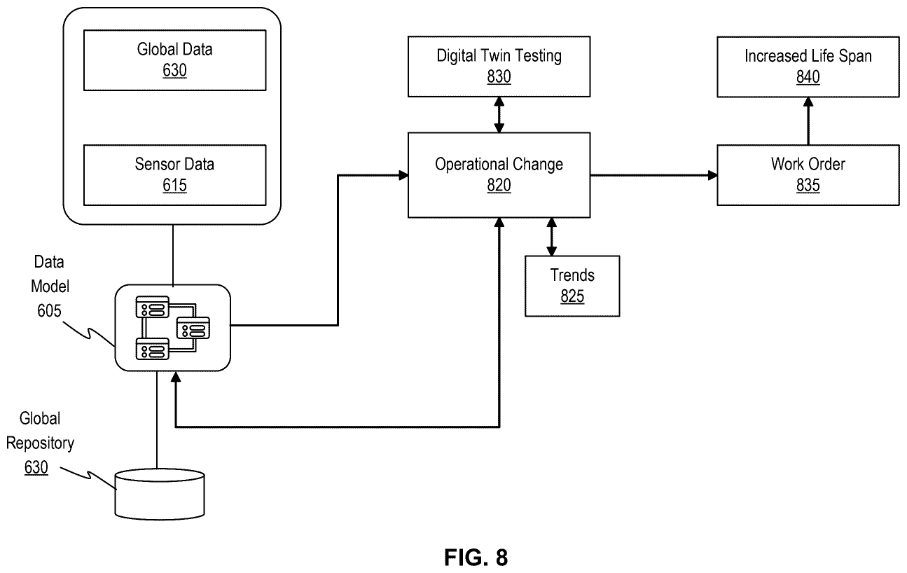

FIG. 8 shows an example of an optimization process flow.

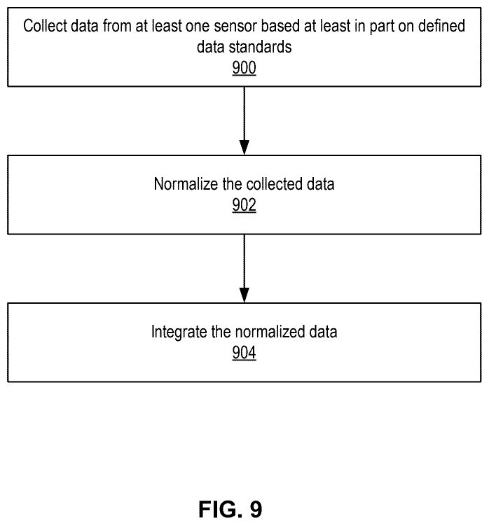

FIG. 9 is a flow diagram illustrating an embodiment of a process for assembling a data pool according to a unified data acquisition framework.

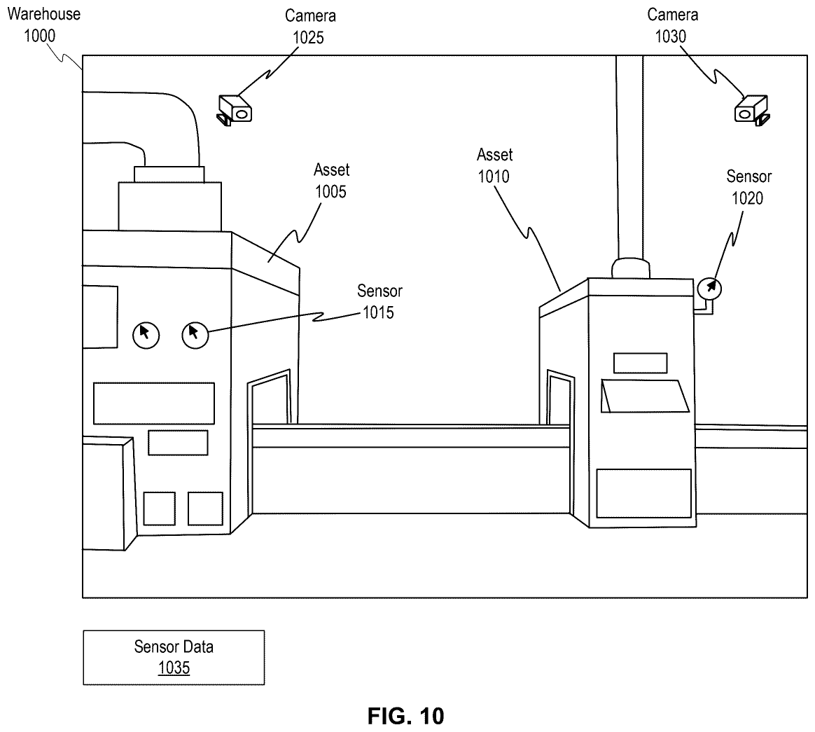

FIG. 10 is a diagram illustrating an example of an environment in which equipment failure may be detected and prevented using operational data.

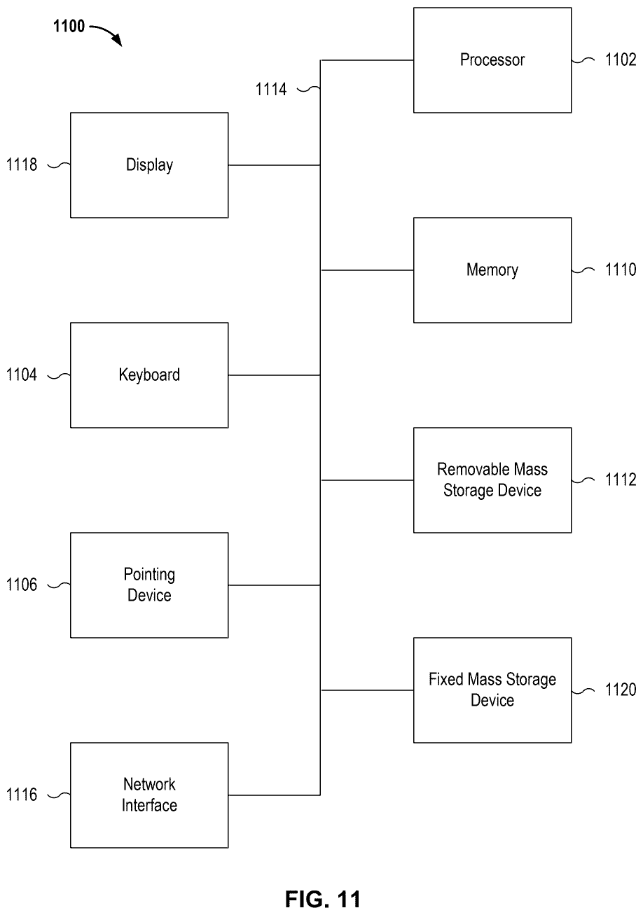

FIG. 11 is a functional diagram illustrating a programmed computer system for detecting and preventing equipment failure using operational data in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Manufacturing and industrial equipment is not only typically extremely expensive to buy, but any failure and downtime it incurs is expensive in terms of both opportunity costs (e.g., goods are not being processed or fabricated, money is being lost) and repair costs. When equipment is repaired at the time of failure, the process is reactive, and, due to the urgency to repair the equipment, parts and labor will be more expensive. Additionally, the repairs could be “quick and dirty,” but not the best long-term solution. Moreover, there is an inverse relationship between the frequency that an equipment breaks or is not being taken care of preventatively and the life expectancy of the equipment, which in turn means it will need to be replaced more frequently. This is undesirable from a business economics as well as an environmental perspective.

Conventional techniques for monitoring equipment attempt to detect or predict failure by detecting an anomaly using sensor data using domain knowledge. However, in one aspect, conventional techniques typically at most use a single machine learning/artificial intelligence (ML/AI) agent (sometimes simply called an “agent”), which results in inefficient or inaccurate predictions regarding fault prediction, preventive maintenance, and the like. The disclosed techniques include using an orchestrator that coordinates among multiple agents to obtain better predictions, assessments, and recommendations associated with equipment. For example, the orchestrator determines whether a first agent's assessment is sufficient (e.g., has an acceptable confidence level). If the first agent's assessment is insufficient, then the orchestrator calls a second agent to make an independent evaluation, provide more information, or otherwise improve the confidence of the first agent's assessment.

The disclosed techniques include an orchestrator that dynamically composes, schedules, and coordinates a network of autonomous agents to manage asset maintenance decisions by selecting from an extensible set of actions based on heterogeneous inputs and inter-agent interactions. The orchestrator processes data streams including, but not limited to, (e.g., real-time or near real-time) sensor telemetry (e.g., temperature, vibration, pressure), historical maintenance records, OEM-prescribed procedures, operator feedback, expert heuristics, environmental conditions, simulation-based forecasts, etc. Based on these inputs, the orchestrator may invoke actions such as querying specific sensors or sensor clusters, validating the applicability of maintenance procedures, scheduling and prioritizing work orders, comparing the outputs of redundant diagnostic agents, triggering counterfactual simulations, initiating collaborative or adversarial evaluations between agents, or temporarily deferring action pending uncertainty resolution. Via the orchestrator, agents may exchange intermediate representations, challenge each other's hypotheses, or converge through confidence-weighted voting or negotiation protocols. In various embodiments, the orchestrator adapts its decision policy in real time based on context such as data completeness, agent reliability, risk thresholds, and asset criticality. This enables resilient, scalable, and continuously improving maintenance orchestration. The architecture is designed to support the integration of future input modalities and novel agent behaviors, allowing for emergent capabilities and domain-specific extensibility.

In another aspect, conventional techniques do not gather and synthesize data from different sources in the disclosed manners. For example, current alternatives do not leverage all operation information from the equipment (for instance, they typically only place external vibration sensors on the equipment and do not take into account the operational data from a programmable logic controller (PLC)) and are not able to map predicted faults to root causes and make recommendations to address them. The disclosed techniques for extracting data from various sources, standardizing them as necessary, and processing the data for use by agents (e.g., forming training data sets) improve the functioning of the agents so that they can make better predictions. Consequently, the technical problem of inaccurate and inefficient equipment failure detection and prevention is solved by the technical solution of an orchestrator and agents that more efficiently and accurately monitor and make predictions regarding equipment by using processed/synthesized operational/sensor data from various sources.

The disclosed techniques for detection and prevention of equipment failure using operational data allow fault patterns to be detected early and prevent equipment from failing by addressing potential failure root causes before they occur. This preserves the equipment's uptime while extending its lifetime and reducing costs, both immediate but also in the long run. As further described herein, the disclosed techniques not only improve the functioning of equipment within various settings such as industrial and consumer environments (e.g., by monitoring the health of the equipment as well as providing recommendations for optimal maintenance schedules) but also more efficiently identify preventive and prescriptive recommendations in a manner that is not capable of being performed by a human.

In various embodiments, a system for detection and prevention of equipment failure using operational data includes an interface that receives information about a state of the equipment from various sources, a data pool including information from the interface, and agents (such as generative artificial intelligence) configured to access the data in the data pool. The agents are trained to assess a condition of the equipment based on the data. The system includes an orchestrator that evaluates an assessment of a first agent. The orchestrator may decide to access another agent for further assessment based on the assessment of the first agent. For example, if the evaluation of the first agent's assessment suggests that a second agent would be helpful for further assessment, then the second agent is accessed for further assessment. The further assessment may include invoking a specialized agent to make a more informed decision about a specific condition, invoking another agent with the same role as the first agent to make an independent recommendation due to a low confidence value of the first agent, etc. Therefore, the orchestrator is able to combine the assessments of multiple agents to make a more accurate predictive or prescriptive recommendation. The orchestrator may further cause a modification to be made to the equipment.

First, an example system will be described in FIGS. 1 and 3. Next, an example process will be described in FIGS. 2A and 2B. Some examples of operational and sensor data synthesis and analysis are shown in FIGS. 4 and 5. Some examples of anomaly detection, forecasting, and optimization are shown in FIGS. 6-8. A process for collecting and integrating data is described in FIG. 9. An example environment in which the disclosed techniques may be applied is shown in FIG. 10. Finally, an example computer system for implementing the disclosed techniques is shown in FIG. 11.

FIG. 1 is a block diagram illustrating an embodiment of a system for detection and prevention of equipment failure using operational data. System 100 includes an interface 135, a data pool 140, one or more agents 150, and an orchestrator 105.

The interface 135 is configured to receive information about a state of equipment from a plurality of sources. Referring briefly to FIG. 10, which depicts a first asset 1005 (equipment) and a second asset 1010 (equipment), information about the state of each asset may be reported by respective sensors 1015 and 1020. Returning to FIG. 1, as further described herein with respect to the data pool 140, the information from the interface may include, without limitation, one or more of the following:
historical information (e.g., a device that accumulates time-series data for a respective area such as a floor),
a configuration,
information associated with another equipment within a threshold similarity of the equipment, or
data collected by a technician.

The information may be obtained via software or hardware. In various embodiments, the plurality of sources includes a PLC. For example, the information may be obtained using a PLC or other control systems that manage the equipment's operations. The PLC collects physical/analog data of the equipment's operation such as vibration and rotation signals (e.g., frequencies, amplitude, phase, etc.) including noise, temperature, airflow, current, voltage, etc. In some aspects, the system may utilize a combination of direct data connections, such as through industrial communication protocols like MQTT, Sparkplug, Modbus, Profibus, or Ethernet/IP, and indirect methods, such as through API calls to existing databases or data historians that store operational data. The system may also include additional sensors that are installed on the equipment to capture physical and analog data, which is then synchronized with the data obtained from the PLC to provide a comprehensive view of the equipment's performance and condition.

The data pool 140 includes information from the interface. For example, information about the state of equipment from various sources collected via the interface may be pooled into the data pool so that the information is accessible by the orchestrator and any number of agents 150, subject to security provisions. Examples of data include operational data 142 and sensor data 144. The examples of data in data pool 140 are merely exemplary and not intended to be limiting as other types of data may be included in the data pool. Data added to the data pool may include data collected by an agent. The agent may perform its own research and determine whether or not to add the research results into the data pool to make the data accessible to other agents.

The operational data 142 may include telemetry data such as run time, down time, service time, output produced, maintenance times, inspections, flags and failures, labor time, repair costs, part costs, any other costs, and so on. The operational data may include run condition data, which refers to data different from the sensor data 144 such as a technician's report on the current condition and status of the asset, location details for the asset, owner information, and so on. The operational data may include a configuration indicating how an equipment was configured for operation.

The sensor data 144 may include sensor data obtained from any sensor associated with a given asset. The sensors may be integrated with the asset or they may be external to the asset, such as environmental sensors that are located externally relative to the asset but that measure the environmental conditions in which the asset is operating. The sensor data 144 may be of any type. Example types of the sensor data include, but are not limited to, numerical data, alphanumeric data, text data, image data, video data, depth data, spectral analysis data, pressure data, temperature data, flow data, speed data, and so on. This sensor data 144 may be generated at a location that is remote from orchestrator 105 or may be generated at the same location where the orchestrator is located. If remote, then the sensor data 144 can be transmitted over one or more networks.

The data pool 140 may include fleet data describing which manufacturer's fleet an asset may be included in. For instance, a particular manufacturer may deploy many units of the same type of equipment to many different consumers. The fleet data can describe to which fleet a consumer's asset belongs. In some cases, the manufacturer may transmit data to the consumers to describe various conditions associated with a fleet of equipment.

The data pool 140 may include feedback data, which refers to data generated at the consumer end. Technicians or other workers may be tasked with performing various actions. Inasmuch as those workers are closest to the asset, it is often the case that those workers identify or derive improved processes for operating on or with those assets. The workers can then provide feedback data to the manufacturers, and that feedback data may trigger the update of a manual, such as perhaps a service manual.

The data pool 140 may include trend data, which refers to data describing various behavioral trends identified for an asset or a group of assets. As an example, a manufacturer can acquire fleet data describing operational characteristics of a particular type of asset. That data can be analyzed to detect patterns or trends in behavior, thereby producing the trend data. It may be advantageous for consumers to be apprised of this trend data; thus, the trend data can be sent to the consumers. In other words, the information in the data pool for a particular equipment may include data associated with another equipment within a threshold similarity of the equipment. As further described herein, the disclosed techniques include identification of similar equipment so that useful information may be shared for similar equipment.

The data pool 140 may include recommendation data, which refers to various recommendations that may be generated by one or more of the consumer or the manufacturer. This data can be used to update practices and other procedures.

The data pool 140 may include prediction data, which refers to data that has been generated and that relates to a prediction as to how an asset may subsequently operate. For instance, the prediction data may predict that a particular part of an asset will likely expire within an upcoming time period, and so that part should be pre-ordered and be ready to be replaced.

The data pool may include any other data such as various libraries of manuals, publicly available asset information, OEM data, forum data, social media data, historical information such as work order and purchase order information, Internet crawled information, etc.

The data of the data pool 140 may be filtered or processed prior to use by orchestrator 105 or agents 150. Filtering algorithms may be applied to remove noise and irrelevant data, enhancing the quality and reliability of the sensor data. By effectively managing and interpreting the diverse data streams from various sensors, the system can detect and diagnose faults with greater accuracy and confidence.

As further described herein, a variety of machine learning algorithms may be used to analyze the collected operational data and sensor readings. These algorithms may include, without limitation:
Random Forest: For classification and regression tasks, particularly effective in handling high-dimensional data and identifying important features.
Support Vector Machines (SVM): Used for both classification and regression, especially useful for separating different fault classes in high-dimensional feature spaces.
Convolutional Neural Networks (CNN): Applied to time-series data from sensors to automatically extract relevant features and patterns indicative of equipment faults.
Long Short-Term Memory (LSTM) networks: Employed for sequence prediction tasks, such as forecasting equipment behavior and detecting anomalies in time-series data.
Gradient Boosting Machines (e.g., XGBoost, LightGBM): Utilized for their high performance in predictive modeling tasks and ability to handle complex relationships in the data.
K-Means Clustering: Used for unsupervised learning tasks, such as grouping similar fault patterns or identifying distinct operational states of equipment.
Isolation Forest: Particularly effective for anomaly detection in high-dimensional datasets, helping to identify rare events or unusual equipment behavior.
Gaussian Process Regression: Applied for probabilistic modeling of equipment behavior and uncertainty quantification in predictions.
Autoencoders: Used for dimensionality reduction and feature learning, helping to compress and reconstruct complex sensor data for more efficient analysis.
Ensemble methods: Combining multiple algorithms to improve overall prediction accuracy and robustness.

These algorithms may be used in combination and are tailored to the specific characteristics of the equipment and the nature of the data being analyzed. The system 100 may dynamically select and apply these algorithms based on the type of analysis required and the performance metrics observed over time.

Agents 110, 115, and 120 (collectively referred to as agents 150) is each configured to access the data in the data pool 140. The agents are trained to assess a condition of the equipment based on the data. Each agent 150 can include or be associated with memory and any number of different tool(s) or APIs, which refer to specialized utility, tooling, or functionality defined for the agent to use.

As used herein, reference to any type of machine learning, LLM, LLM agent, or artificial intelligence can include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), generative pre-trained transformer(s) (GPT), long short-term memory networks, K-means clustering, isolation forests, autoencoders, gaussian process regression, ensemble methods, or any other type of intelligent computing system. Any amount of training data can be used (and perhaps later refined) to train the machine learning algorithm to dynamically perform the disclosed operations.

The orchestrator is configured to perform a process such as the one further described herein with respect to FIGS. 2A and 2B. For example, the orchestrator evaluates an assessment of a first agent. In response to the evaluation of the assessment of the first agent indicating access of a second agent, the orchestrator accesses the second agent for further assessment. The orchestrator provides an output or causes a modification to be made to the equipment.

The orchestrator 105 may be implemented as an automated program that is tasked with performing different actions based on input. In various embodiments, the orchestrator 105 is communicatively coupled to one or more agents 150. Examples of agents include an ML or AI engine. The ML or AI engine may include or be associated with an LLM. In various embodiments, the orchestrator 105 is implemented by or includes one or more agents 150. The orchestrator and agent(s) are able to use various application programming interfaces (APIs) to perform various actions. The APIs provide the orchestrator/agent an interface for communicating directly or indirectly with a system, person, or equipment to achieve a specific desired outcome. For example, the orchestrator/agent may communicate with a system or person so that a change can be made to equipment. As another example, automation may be used to change an operating state or other aspect of the equipment.

In some implementations, orchestrator 105 is a cloud service operating in a cloud 130 environment. In some implementations, orchestrator 105 is a local service operating on a local device. In some implementations, orchestrator 105 is a hybrid service that includes a cloud component operating in the cloud 130 and a local component operating on a local device. These two components can communicate with one another.

In operation, orchestrator 105 causes a modification to be made to equipment or outputs a maintenance recommendation, prediction, or request for more information. The orchestrator may make its determination using asset metadata (e.g., any information associated with an asset, including OEM manual information, Internet data about the asset, forum data, social media data, etc.) and output from one or more agents 150. For instance, orchestrator 105 receives, via interface 135 information about a state of equipment from various sources. The data may be from data pool 140. The data pool may include non-standardized data, asset metadata, run condition, sensor data, or the like. In some scenarios, the interface 135 is obtained from OEM manuals, non-OEM manuals, Internet data, forums, social media data, and so on, without limit. The orchestrator may provide an output 160 for (or forming a basis for) anomaly detection, forecasting, optimization, among other things, as further described herein. The output may be provided via an API.

The following figure shows an example of a process that can be performed by the system of FIG. 1, describing in more detail how the orchestrator may function.

FIG. 2A is a flow diagram illustrating an embodiment of a process for detection and prevention of equipment failure using operational data. This process may be implemented on orchestrator 105 of FIG. 1.

In the example shown, the process begins by receiving information about a state of the equipment from a plurality of sources (200). A data pool may be formed including information from the interface.

The information (e.g., operational or sensor data) may be filtered or otherwise processed to extract parameters. For example, the process can monitor parameters in the operational data. The system monitors a variety of parameters in the operational data, which may include but are not limited to: rotational speed, torque, power output, electrical current, voltage levels, temperature readings, pressure levels, fluid flow rates, vibration frequencies, vibration amplitude, acoustic emissions, and chemical composition of lubricants. These parameters are indicative of the equipment's health and performance, and changes in these parameters can signal the onset of potential issues or malfunctions.

In various embodiments, the process employs a sophisticated array of filtering algorithms to enhance the quality and reliability of sensor data. These algorithms may include, without limitation:
Low-pass and high-pass filters to remove frequency components outside the range of interest for specific fault types. For instance, a low-pass filter might be applied to vibration data to focus on low-frequency structural issues, while a high-pass filter could be used to isolate high-frequency bearing faults.
Kalman filters for real-time noise reduction and state estimation, particularly useful for sensors with known noise characteristics or when dealing with dynamic systems.
Median filters to remove impulse noise or outliers that could otherwise skew the analysis, especially effective for temperature and pressure sensor data.
Wavelet denoising techniques, which can effectively separate signal from noise across different frequency bands, preserving important transient features that might be indicative of equipment faults.
Adaptive filters that can adjust their parameters based on the changing characteristics of the input signal, making them particularly useful for handling non-stationary noise in industrial environments.
Principal Component Analysis (PCA) for dimensionality reduction, helping to identify the most significant features in multi-sensor data and filter out less relevant information.
Independent Component Analysis (ICA) to separate mixed signals from multiple sensors, useful in isolating specific fault signatures from complex, overlapping sensor outputs.
Particle Filters: Applied in non-linear and non-Gaussian scenarios, particularly useful for tracking and predicting system states in complex industrial processes.
Moving Average Filters: Used to smooth out short-term fluctuations and highlight longer-term trends in sensor data.
Notch Filters: Employed to remove specific frequency components, such as those associated with known environmental vibrations or electrical interference.
Wiener Filters: Applied for optimal noise reduction in stationary signals, particularly useful in scenarios where the signal and noise spectra are known.
Savitzky-Golay Filters: Used for smoothing and differentiation of data, particularly effective in preserving higher moments of the signal.

The system may dynamically select and apply these filtering algorithms based on the specific sensor type, the nature of the data being collected, and the current operating conditions of the equipment. This adaptive approach ensures that the most appropriate filtering technique is used for each data stream, maximizing the signal-to-noise ratio and enhancing the system's ability to detect subtle changes that may indicate impending equipment failure.

Furthermore, the system may employ machine learning techniques to continuously refine and optimize these filtering algorithms. By analyzing the effectiveness of different filtering approaches in various scenarios, the system can learn to automatically select and configure the most suitable filtering methods for each specific equipment and sensor combination, further improving the accuracy and reliability of fault detection over time.

The process may proceed to execute a task by performing and/or repeating 202 to 206 as represented by the dashed box and as further described herein. The process optionally drafts a plan to carry out the task. The task plan may be helpful for the orchestrator to track progress towards task objectives. The process may determine whether to repeat one or more of 200 to 206 based on progress towards completing task objectives.

The process evaluates an assessment of a first agent (202). The orchestrator's assessment may include determining whether the analysis/output of the first agent is sufficiently deep, whether the first agent's output raises new questions, whether the output of the first agent is confusing or contradictory. Depending on the evaluation of the output, a second agent could be called to refine, compare, retrieve more information, generate hypotheses, synthesize data, etc.

The process determines whether the assessment of the first agent indicates that a second agent is to be accessed (204). For example, if the assessment of the first agent includes an indication to acquire additional data to improve confidence, a second agent may be invoked to gather or provide more data. As another example, the assessment of the first agent may include adding a sensor. Adding a sensor may help gather more data and/or increase the confidence of the prediction made by the first agent. For example, the first agent may identify a gap in the data, and the addition of a sensor may help to fill the gap in the data and lead to greater confidence or a better prediction/recommendation. The assessment of adding a sensor may include a specific location or part in which to add or turn on the sensor, the type of sensor, etc. For example, if the gap in the data is vibration data for a particular part, then instructions to add a vibration sensor to the part or area may be output.

If the assessment of the first agent indicates that a second agent is to be accessed, the process proceeds to access the second agent for further assessment in response to the evaluation of the assessment of the first agent indicating access of a second agent (206). Otherwise the process proceeds to 208. Referring to 206, accessing a second agent helps to more thoroughly examine a problem and/or increase a level of confidence on the assessment made by the first agent, among other things.

The process causes a modification to be made to the equipment (208). An example of a modification is sending an instruction to the equipment. For example, the modification includes turning on a sensor. Another example of a modification is sending an instruction to a system, which in turn changes the equipment such as an operating state of the equipment.

In various embodiments, the process includes outputting: a maintenance recommendation, a prediction or request for more information, or determining a generalization across at least one of: assets within a threshold similarity of each other and a plurality of instances of assets. Referring briefly to FIG. 1, the orchestrator may provide these outputs. The output may be displayed on a user interface associated with a software application such as a Web browser or smartphone application. As another example, the output may provide a notification in another manner such as sending a text message or email to a user or group of users.

202-206 is but an example of how an orchestrator may utilize the agents 150 of FIG. 1. The orchestrator may access one or more of the agents 150. For example, in lieu of 204 being an assessment of the first agent indicating a second agent is to be accessed, the orchestrator may determine that additional independent research or information should be gathered. The orchestrator may then re-evaluate the assessment of the first agent based on the additional research or information. The next figure shows an example of another way the orchestrator may utilize the agents 150 and generalizes the example of FIG. 2A.

FIG. 2B is a flow diagram illustrating an embodiment of a process for detection and prevention of equipment failure using operational data. This process may be implemented on orchestrator 105 of FIG. 1. Each of the steps are like their counterparts in FIG. 2A unless otherwise described herein.

In the example shown, the process begins by receiving information about a state of the equipment from a plurality of sources (200). A data pool may be formed including information from the interface.

The process obtains a task plan (220). The task plan may guide the orchestrator in coordinating multiple agents to complete a task such as tracking progress towards task objectives. Referring briefly to FIG. 1, one or more agents of the agents 150 may be responsible for task planning and may be called as needed to determine a task plan for the orchestrator. Thus, an orchestrator may obtain a task plan from an agent. Alternatively, the orchestrator may draft its own task plan. The orchestrator may obtain a task plan from an agent and modify the task plan before carrying out the task plan.

The process performs an evaluation (210). For example, the process evaluates an output of a first agent. As described with respect to 202, the assessment may include determining whether the analysis/output of the first agent is sufficiently deep, whether the first agent's output raises new questions, whether the output of the first agent is confusing or contradictory.

The process determines a next action to take (214). Depending on the evaluation of the output, the orchestrator may determine possible next actions are: refine, compare, retrieve more information, generate hypotheses, synthesize data, etc.

The process performs the next action (216). The orchestrator may take the action itself, e.g., obtain additional data or may call one or more of the agents 150 to take the action.

If the stopping condition is met at 216, the proceeds to 208 to cause a modification to be made to the equipment (208). The stopping condition may be the orchestrator's task plan being sufficiently complete. An example of a modification is sending an instruction to the equipment. For example, the modification includes turning on a sensor. Otherwise, if the stopping condition is not met, the process returns to 210 to evaluate a result of performing the next action. For example, if another agent is called to perform the action, the process evaluates an output of the agent to determine if further actions are to be taken.

In various embodiments, 210-216 may be repeated as necessary because there is no fixed pipeline so that the process flow depends on an output. The decisions may be made stepwise so that the next action is selected dynamically at 212. The logic of the process shown here is evaluation driven so that the output quality (as determined by the evaluation steps) guides the process flow. FIG. 3 is a block diagram illustrating an embodiment of a system for detection and prevention of equipment failure using operational data. System 300 includes an anomaly detector 310, a root cause analyzer 320, a prediction/recommendation engine 330, and a generalization engine 340.

In various embodiments, by capturing as much relevant data as possible around the operation of the equipment, over time it is possible to detect trends and patterns of wear and tear on different subsystems and parts of the equipment, identify the possible root causes, and address them before failure occurs. It is not necessary but possible to aggregate these trends and patterns across equipment of similar makes, models, and even “vibration signatures” to achieve higher fidelity with less data. By understanding failure modes and fault patterns of similar equipment, the embodiments are able to make predictions and recommendations to help prevent these failures before they occur.

The anomaly detector 310 is configured to detect anomalies or unexpected behavior in equipment. The anomaly detector may include a digital signal processor 312 that uses DSP-based anomaly detection techniques, such as spectral kurtosis and envelope analysis, to identify outliers in the data that could indicate a malfunction. It has been observed that these techniques are particularly effective in detecting faults in rotating machinery by analyzing the frequency content of vibration signals. The integration of DSP techniques enhances the anomaly detector's ability to detect and classify faults, even in complex, noisy industrial environments, leading to more accurate and reliable predictive maintenance strategies. An example of a process for anomaly detection is further described with respect to FIG. 6.

The root cause analyzer 320 is configured to identify possible causes of detected faults or anomalies. The disclosed advanced analytics and machine learning capabilities enable the orchestrator to not just predict potential failures but also to identify the root causes of these failures. This is in contrast to some traditional alternatives that may be limited to simple threshold-based monitoring or anomaly detection without the ability to diagnose underlying issues.

In various embodiments, the root cause analyzer identifies the possible root causes of detected faults by analyzing the correlation between the observed data anomalies and the known failure modes of the equipment. In some aspects, the root cause analyzer may employ diagnostic algorithms that compare the detected patterns of wear and tear against a database of fault signatures, which are characteristic indicators of specific types of failures. The root cause analyzer may also take into account the operational context of the equipment, such as load conditions, operating cycles, and maintenance history, to provide a more accurate diagnosis. By integrating this multi-dimensional analysis, the root cause analyzer can pinpoint the underlying issues that are likely to lead to equipment failure, such as misalignment, lubrication degradation, or thermal stress, among others. This enables maintenance personnel to target their efforts more effectively and implement corrective actions that address the root cause of the problem, rather than just the symptoms.

The prediction/recommendation engine 330 is configured to make predictions and recommendations to prevent failures before they occur. The prediction/recommendation engine makes predictions and recommendations to prevent failures before they occur by employing prognostic algorithms that analyze the current state of the equipment and its historical performance data. In some aspects, the prediction/recommendation engine may use machine learning techniques to build predictive models that estimate the remaining useful life of equipment components and systems. These models take into account the trends and patterns of wear and tear, as well as the operational conditions under which the equipment is used. The prediction/recommendation engine may use past maintenance history to make predictions and recommendations.

The prediction/recommendation engine can recommend specific actions when it detects potential equipment failure, which may include, but are not limited to, scheduling maintenance or repair sessions, adjusting operational parameters to alleviate stress on the equipment, replacing worn or damaged components, recalibrating the system for improved accuracy, cleaning or lubricating parts, tightening loose connections, and updating firmware or software to address identified issues. These actions are tailored to the nature of the detected anomaly and the type of equipment affected, ensuring that the response effectively mitigates the risk of failure.

The prediction/recommendation engine may recommend various actions when it detects potential equipment failure. These actions may include, without limitation:
Immediate Inspection: Scheduling a targeted inspection of the equipment by maintenance personnel to verify the detected issue and assess its severity.
Preventive Maintenance: Recommending specific maintenance tasks tailored to address the detected fault, such as lubrication, alignment, or component replacement.
Operational Adjustments: Suggesting modifications to operational parameters, such as reducing load or speed, to mitigate stress on the affected components and extend equipment life until maintenance can be performed.
Part Replacement: Recommending the replacement of specific components that have been identified as nearing the end of their useful life or showing signs of imminent failure.
Emergency Shutdown: In cases of severe or imminent failure risk, recommending an immediate controlled shutdown of the equipment to prevent catastrophic failure and ensure safety.
Condition Monitoring Intensification: Increasing the frequency and detail of data collection and analysis for the affected equipment to closely track the progression of the detected issue.
Root Cause Analysis: Initiating a detailed investigation to identify the underlying causes of the detected fault, which may involve analyzing historical data and operational patterns.
Maintenance Schedule Optimization: Adjusting the overall maintenance schedule for the equipment to incorporate the newly detected issue and optimize resource allocation.
Operator Training: Recommending specific training or awareness programs for operators to help them recognize early signs of the detected fault type in the future.
Equipment Redesign or Upgrade: In cases of recurring issues, suggesting long-term solutions such as equipment redesign or upgrades to address systemic problems.

In various embodiments, recommended actions are prioritized based on the severity of the detected issue, its potential impact on production, and the estimated time to failure. The prediction/recommendation engine may also provide guidance on the urgency of each action and the potential consequences of delaying intervention.

An example of a process for making predictions or recommendations is further described with respect to FIGS. 7 and 8.

The generalization engine 340 is configured to aggregate trends and patterns across equipment of similar makes, models, and parameters (such as vibration signatures) to achieve higher fidelity with less data. In various embodiments, the generalization engine employs data fusion and clustering techniques. In some aspects, the generalization engine may collect and analyze data from multiple units of the same or similar type of equipment, allowing it to identify common patterns and anomalies that are indicative of specific failure modes. By comparing the operational data and sensor readings from these similar equipment, the generalization engine can enhance its predictive accuracy even with limited data from a single unit. This cross-equipment analysis benefits from the collective learning process, where insights gained from one machine can be applied to others with similar characteristics. Additionally, the generalization engine may use machine learning algorithms to classify equipment based on their vibration signatures and other operational parameters, creating a reference library of equipment profiles. This enables the generalization engine to recognize and diagnose issues more effectively by referencing the aggregated data from the collective pool of similar equipment, leading to more accurate predictions and tailored recommendations for preventative maintenance.

Two pieces of equipment may be considered similar if they are within a threshold of similarity to each other. For example:
their versions are within some threshold.
a generator that is used in a wind turbine may be considered similar to a generator that is used in a water turbine, even if they are different models because both generators work in fluids.
Same manufacturer, same model, same revision (could be installed in separate facilities)
Same manufacturer, same model family (different revisions)
Same manufacturer, same asset type (different models), e.g. both vertical multistage pumps
Same asset type, different manufacturers, e.g., both multistage centrifugal pumps manufactured by different manufacturers
Same asset type and operating conditions, e.g., submersible sewage pumps from different brands, used in coastal lift stations.
Same functional role in the system, e.g., a diaphragm pump and a centrifugal pump are both used for transferring wastewater in separate facilities.

The generalization engine 340 may employ various data fusion and clustering techniques to aggregate trends and patterns across equipment of similar makes, models, and signatures (such as “vibration signatures”). These techniques may include, without limitation:
Hierarchical Clustering: This technique is used to group similar equipment based on their operational characteristics and vibration signatures, creating a tree-like structure of clusters that can be analyzed at different levels of granularity.
Dempster-Shafer Fusion: This method combines evidence from multiple sources to make inferences about equipment conditions, particularly useful when dealing with uncertain or conflicting data from different sensors or equipment types.
Kalman Filtering: Used for data fusion in dynamic systems, this technique can combine data from multiple sensors to provide optimal estimates of equipment state, even in the presence of noise and uncertainties.
Principal Component Analysis (PCA): This technique is applied to reduce the dimensionality of the data while retaining the most important features, allowing for easier comparison and clustering of equipment based on their key characteristics.
Fuzzy C-Means Clustering: This soft clustering technique allows equipment to belong to multiple clusters with varying degrees of membership, which is particularly useful when dealing with equipment that shares characteristics across different categories.
Spectral Clustering: This technique is effective for clustering equipment based on their vibration signatures, as it can capture complex, non-linear relationships in the data.
Gaussian Mixture Models (GMM): These probabilistic models can represent complex distributions of equipment characteristics and are useful for clustering and anomaly detection across similar equipment types.
Self-Organizing Maps (SOM): This unsupervised learning technique can be used to visualize high-dimensional data in a low-dimensional space, helping to identify patterns and clusters across different equipment types.
Ensemble Clustering: This approach combines multiple clustering algorithms to provide more robust and reliable groupings of equipment based on their characteristics and operational patterns.
Transfer Learning Techniques: These methods allow the system to transfer knowledge gained from one type of equipment to another, improving the accuracy of predictions and classifications for new or data-scarce equipment types.

These techniques may be used in combination and may be adaptively applied based on the specific characteristics of the equipment being analyzed and the nature of the data available. The generalization engine may dynamically select and configure these techniques to optimize their effectiveness in aggregating trends and patterns across different types of industrial equipment.

In operation, the orchestrator may utilize each of components 310, 320, 330, and 340 as follows. The anomaly detector 310 observes the following symptoms (based on sensor and/or operational data): elevated temperature, abnormal vibration, and/or current fault. The root cause analyzer 320 identifies that these symptoms are due to wear and tear. The prediction/recommendation engine 330 recommends that a frequency of maintenance of a particular part be changed, e.g., replaced every 30 days rather than every 60 days. The generalization engine 340 may use this information. The orchestrator's ability to aggregate and analyze data across multiple units of similar equipment enhances its predictive accuracy and allows for more effective preventative maintenance strategies, which are typically not available in conventional solutions. This cross-equipment analysis also contributes to a more robust dataset, which improves the orchestrator's learning capabilities and the precision of its recommendations, thereby reducing the likelihood of false positives or negatives in fault detection.

In various embodiments, the orchestrator 105 takes various measures to ensure its performance in terms of accuracy, speed, and reliability in fault detection and prevention. These measures may include, without limitation:
Continuous Model Evaluation: Regularly assessing the performance of fault detection models using metrics such as precision, recall, and F1-score to ensure ongoing accuracy.
Real-time Processing Optimization: Employing distributed computing and parallel processing techniques to handle large volumes of sensor data in real-time, ensuring rapid fault detection and response.
Redundancy and Fault Tolerance: Implementing redundant data collection and processing systems to maintain reliability in case of component failures.
Adaptive Thresholding: Dynamically adjusting fault detection thresholds based on equipment operating conditions and historical performance to improve accuracy.
Cross-validation Techniques: Utilizing k-fold cross-validation and other validation methods to ensure the robustness of fault detection models across different scenarios.
Ensemble Methods: Combining multiple fault detection algorithms to leverage their collective strengths and improve overall accuracy and reliability.
Anomaly Detection Benchmarking: Regularly comparing the system's performance against benchmark datasets and industry standards to ensure state-of-the-art accuracy.
Continuous Learning and Model Updates: Implementing online learning algorithms that allow the system to adapt to changing equipment conditions and new fault types over time.
Data Quality Assurance: Employing advanced data cleaning and preprocessing techniques to ensure the reliability of input data for fault detection models.
Performance Monitoring and Alerting: Implementing real-time monitoring of the system's performance metrics with automated alerts for any degradation in accuracy, speed, or reliability.

These measures may be implemented in combination and may be continuously refined based on system performance and evolving industry best practices. The orchestrator 105 may also employ adaptive techniques to optimize its performance across different types of equipment and operating conditions.

The following figures show some examples of how operational and sensor data is analyzed.

FIG. 4 shows sensor data 400, which is representative of the sensor data 144. The sensor data 400 may be collected for any duration of time. Orchestrator 105 is able to use the sensor data 400 to generate performance trends 405 for the various different assets. To illustrate, orchestrator 105 generated a performance trend for Asset A 410 and a performance trend for Asset B 415. This is an example of how historical behavior data for a given asset can be determined.

Trends and patterns of wear and tear on different subsystems and parts of the equipment may be detected or determined. For example, the orchestrator 105 employs advanced data analytics, machine learning algorithms, and digital signal processing (DSP) techniques to analyze the collected operational data and sensor readings. In some aspects, the orchestrator may utilize statistical analysis, pattern recognition, and predictive modeling in conjunction with various DSP methods to identify deviations from normal operational patterns that may indicate wear and tear.

By continuously monitoring the equipment, the orchestrator can detect subtle changes in the parameters that may not be immediately apparent to human operators. These changes are then processed using DSP techniques such as Fourier transforms, wavelet analysis, and time-frequency analysis to extract meaningful features from the raw signals. The processed data is then correlated with historical data and known failure modes to identify trends and patterns that may signal the onset of equipment degradation or impending failure.

FIG. 5 shows an example of correlations and predictions generated based on that data. The correlations and predictions may be determined by orchestrator 105 of FIG. 1. FIG. 5 shows a plot of sensor data. Notice, there is a peak in the sensor data near the middle of the graph. Similarly, there is a peak in the chart of the down time. The sensor anomaly could be correlated as happening right before a downtime event. A review of the sensor data and the down time may unveil a correlation between the peak in the sensor data and the peak in the down time. For instance, the sensor data shows an anomaly occurring in the central area of the graph. It is likely that the anomaly caused the down time for the asset. The embodiments are able to analyze the sensor data and generate correlations and predictions based on that data.

The analysis of operational and sensor data may be useful for anomaly detection, forecasting, and optimization as shown in the following figures.

FIG. 6 shows an example of anomaly detection process flow 600. The process flow can be performed by orchestrator 105 (in cooperation with agents 150) using the data pool 140.

Orchestrator 105 accesses a data model 605, e.g., via an API. Here, the data model 605 includes various different types of data, including, but not limited to, work history 610 data for a given asset, sensor data 615 for the asset, asset metadata 620 for the asset, and past behavior 625 for the asset. The data model 605 may be based on a type of global repository 630 that may be globally available to different APIs, including the anomaly detection API. An example of the global repository 630 is data pool 140 of FIG. 1.

Using the information included in the data model 605, the orchestrator 105 is able to identify a deviation in the asset's behavior, where this deviation is referred to as an “anomaly,” as shown by anomaly identification 635. The orchestrator 105 can then be triggered to diagnose the anomaly, as shown by LLM diagnosis 640. By “diagnose,” it is generally meant that the orchestrator 105 is tasked with attempting to identify a source and a cause 645 for the anomaly.

Some of the faults that can be detected include, but are not limited to:
bearing and gear issues (erosion, wear, eccentricity);
belt and pulley wear;
rotor and stator problems (loose bars, windings, eccentricity);
electrical faults (current spikes, phase imbalances, overload);
mechanical issues (misalignment, looseness, resonance);
fluid-related problems (cavitation, turbulence, pump recirculation);
structural concerns (pipe deformation, excessive vibrations); and
operational anomalies (lubrication faults, excessive power consumption).

In various embodiments, the process 600 handles different types of faults by utilizing specialized algorithms and diagnostic tools tailored to each fault type. In some aspects, the process 600 may incorporate vibration analysis techniques to detect bearing erosion and belt wear by monitoring changes in frequency and amplitude patterns that are characteristic of these issues. For electrical faults, the process 600 may analyze current and voltage signatures to identify irregularities such as spikes, drops, or harmonics that suggest problems like short circuits, insulation breakdown, or phase unbalance. Each type of fault has associated data patterns and signatures that the system is trained to recognize through machine learning models that have been fed with a large dataset of fault examples. When a potential fault is detected, the process 600 cross-references the observed data against the known signatures of various faults to diagnose the specific issue with high accuracy. This targeted approach allows for precise identification and categorization of faults, enabling the process 600 to recommend the appropriate corrective actions to address the identified problem.

The process 600 employs a comprehensive suite of statistical analysis, pattern recognition, and predictive modeling techniques in conjunction with various DSP methods to identify deviations from normal operational patterns. These techniques may include, without limitation:
Time Series Analysis: Techniques such as ARIMA (Autoregressive Integrated Moving Average) and SARIMA (Seasonal ARIMA) are used to model temporal dependencies and detect anomalies in time-series data.
Spectral Analysis: Fourier transforms and power spectral density estimation are applied to identify frequency components that may indicate equipment faults.
Wavelet Analysis: Used for multi-resolution analysis of signals, allowing detection of transient events and localized frequency changes that may signify equipment issues.
Statistical Process Control (SPC): Techniques like Shewhart charts and CUSUM (Cumulative Sum) control charts are employed to monitor process stability and detect shifts in equipment performance.
Multivariate Statistical Techniques: Principal Component Analysis (PCA) and Partial Least Squares (PLS) are used for dimensionality reduction and feature extraction from high-dimensional sensor data.
Pattern Recognition: Techniques such as Dynamic Time Warping (DTW) and Hidden Markov Models (HMM) are used to identify specific patterns in sensor data that may indicate fault conditions.
Regression Analysis: Various regression techniques, including linear regression, polynomial regression, and logistic regression, are used to model relationships between different operational parameters and predict future equipment behavior.
Bayesian Networks: Used for probabilistic modeling of complex systems, allowing for inference of equipment state based on observed sensor data.
Clustering Algorithms: K-means, DBSCAN, and hierarchical clustering are employed to group similar operational states and identify outliers that may represent abnormal conditions.
Change Point Detection: Algorithms such as PELT (Pruned Exact Linear Time) are used to identify abrupt changes in the statistical properties of sensor data, which may indicate the onset of equipment faults.

These techniques may be used in combination with DSP methods such as filtering, demodulation, and envelope analysis to extract meaningful features from raw sensor data and identify subtle deviations from normal operational patterns.

In various embodiments, the process 600 employs various DSP-based anomaly detection techniques to identify outliers in the data that could indicate a malfunction. In some aspects, these techniques may include:
Spectral Kurtosis: This technique is particularly effective for detecting transient signals in vibration data, which can be indicative of bearing faults or other mechanical issues.
Envelope Analysis: Used to extract and analyze the modulating signals in vibration data, especially useful for detecting faults in rotating machinery such as bearings and gears.
Cepstrum Analysis: This technique is applied to identify periodic structures in the log spectrum of a signal, which can reveal harmonics and sidebands associated with specific fault types.
Hilbert-Huang Transform: This adaptive method is used for analyzing non-linear and non-stationary signals, allowing for the detection of subtle changes in equipment behavior that may not be apparent with traditional Fourier-based methods.
Empirical Mode Decomposition (EMD): Used to decompose complex signals into a set of intrinsic mode functions, enabling the isolation and analysis of specific frequency components that may indicate equipment faults.
Singular Spectrum Analysis (SSA): This technique is applied to decompose time series data into trend, periodic, and noise components, facilitating the detection of anomalies in the underlying signal structure.
Wavelet Packet Decomposition: Used for multi-resolution analysis of signals, allowing for the detection of localized time-frequency anomalies that may be indicative of equipment faults.
Higher-Order Statistics: Techniques such as bispectrum and trispectrum analysis are employed to detect non-linear interactions in the signal that may be associated with developing faults.
Short-Time Fourier Transform (STFT): Used for time-frequency analysis of non-stationary signals, enabling the detection of transient events and frequency shifts that may indicate equipment malfunctions.
Cyclostationary Analysis: Applied to signals with periodic statistics, this technique is particularly useful for detecting faults in rotating machinery where the signal characteristics vary cyclically with the rotation of the machine.

These DSP-based techniques may be used in combination and may be adaptively applied based on the specific characteristics of the equipment being monitored and the nature of the data being analyzed. The process 600 may dynamically select and configure these techniques to optimize their effectiveness in detecting anomalies across different types of industrial equipment and operating conditions.

In various embodiments, the process 600 utilizes a variety of specific algorithms and diagnostic tools to handle different types of faults, such as bearing erosion, belt wear, electrical faults, etc. These may include, without limitation:
Envelope Analysis: Particularly effective for detecting bearing faults by analyzing the modulation of high-frequency resonances caused by impact forces.
Order Analysis: Used to identify faults in rotating machinery by separating speed-related components from vibration signals.
Motor Current Signature Analysis (MCSA): Employed to detect electrical faults in motors by analyzing the frequency spectrum of the motor current.
Wavelet Analysis: Applied to detect transient events and localized defects in both mechanical and electrical systems.
Thermography: Used to identify hot spots that may indicate electrical faults or excessive friction in mechanical components.
Acoustic Emission Analysis: Effective for detecting early-stage defects in bearings and other high-stress components.
Oil Analysis: Used to detect wear particles and contaminants that may indicate bearing erosion or other mechanical issues.
Partial Discharge Analysis: Applied to detect insulation degradation in electrical systems.
Vibration Analysis: Employing techniques such as Fast Fourier Transform (FFT) and Cepstrum analysis to identify specific fault frequencies associated with different mechanical issues.
Power Quality Analysis: Used to detect electrical faults by analyzing voltage and current waveforms for distortions and anomalies.

These algorithms and tools may be used in combination, with their outputs integrated to provide a comprehensive diagnosis of the equipment's condition. The process 600 may adaptively select and apply these techniques based on the specific type of equipment and the nature of the detected anomaly.

The orchestrator 105 can identify the possible root causes of detected faults/anomalies. The orchestrator 105 identifies the possible root causes of detected faults by analyzing the correlation between the observed data anomalies and the known failure modes of the equipment. In some aspects, the orchestrator 105 may employ diagnostic algorithms that compare the detected patterns of wear and tear against a database of fault signatures, which are characteristic indicators of specific types of failures. The orchestrator 105 may also take into account the operational context of the equipment, such as load conditions, operating cycles, and maintenance history, to provide a more accurate diagnosis. By integrating this multi-dimensional analysis, the orchestrator 105 can pinpoint the underlying issues that are likely to lead to equipment failure, such as misalignment, lubrication degradation, or thermal stress, among others. This enables maintenance personnel to target their efforts more effectively and implement corrective actions that address the root cause of the problem, rather than just the symptoms.

The process 600 may use various diagnostic algorithms to compare detected patterns of wear and tear against a database of fault signatures to detect root causes. These algorithms may include, without limitation:
Pattern Matching Algorithms: These algorithms use techniques like cross-correlation and dynamic time warping to compare observed patterns with known fault signatures in the database.
Fuzzy Logic Systems: These systems can handle imprecise or incomplete data, allowing for more flexible matching of detected patterns to fault signatures.
Neural Network Classifiers: Trained on a large dataset of fault signatures, these networks can classify new patterns into known fault categories.
Decision Tree Algorithms: These algorithms can efficiently navigate through a hierarchy of fault characteristics to identify the most likely fault type.
Bayesian Networks: These probabilistic models can infer the most likely fault type based on observed patterns and prior knowledge of fault probabilities.
Support Vector Machines (SVM): These algorithms can effectively separate different fault classes in high-dimensional feature spaces.
K-Nearest Neighbors (KNN): This algorithm classifies patterns based on their similarity to known fault signatures in the database.
Random Forest Classifiers: These ensemble models can handle complex relationships between features and are robust against overfitting.
Gradient Boosting Machines: These algorithms can capture subtle differences between fault types and are particularly effective for multiclass classification problems.
Convolutional Neural Networks (CNN): When applied to time-series or spectral data, CNNs can automatically extract relevant features for fault classification.

These algorithms may be used in combination, with their outputs potentially weighted or ensembled to provide a more robust diagnosis. The process 600 may also employ adaptive techniques to continuously update and refine the fault signature database based on new data and confirmed diagnoses.

After identifying the source and the cause 645, the orchestrator 105 can then generate an alert 650 to a responsible party and can generate a work order 655 that includes instructions on how to potentially resolve the anomaly. If the performance of the work order 655 results in a successful resolution of the anomaly, then the orchestrator 105 can be notified. This notification can result in fine tuning or further training the orchestrator 105. If no successful resolution is found, then a new attempt can be made by the orchestrator 105. This iterative process can be repeated until a successful resolution is found. Thus, the embodiments can employ a feedback loop 660 for successful and not-yet successful attempts, and agents 150 associated with the orchestrator 105 in particular can then be retrained 665 to adopt successful attempts or to try new operations. Information indicating both success and failure can be included in the data model 605 to assist in avoiding redundant and repetitive potential solutions.

By continuously updating agents with new data, the orchestrator can provide dynamic predictions that reflect the current health of the equipment. When the orchestrator anticipates a potential failure, it generates recommendations for maintenance actions that can be taken to mitigate the risk. These recommendations may include specific repairs, adjustments, or replacements that are likely to prevent the failure from occurring. The orchestrator may also suggest changes to the operational parameters of the equipment to reduce stress and wear, thereby extending its lifespan. Additionally, the orchestrator can schedule these maintenance activities at times that minimize disruption to the production process, further enhancing the efficiency and reliability of the industrial operation.

In various embodiments, the process 600 employs various adaptive learning algorithms that continuously refine the fault detection models based on feedback from maintenance outcomes and expert input. These algorithms may include, without limitation:
Online Learning Algorithms: Such as Stochastic Gradient Descent (SGD) and its variants, which allow the system to update its models incrementally as new data becomes available.
Reinforcement Learning: Techniques like Q-learning or Deep Q-Networks (DQN) that can learn optimal decision-making strategies for fault detection and maintenance scheduling based on the outcomes of previous actions.
Ensemble Learning with Dynamic Weighting: Methods like AdaBoost or Gradient Boosting, where the weights of individual models in the ensemble are dynamically adjusted based on their performance on recent data.
Transfer Learning: Algorithms that can adapt pre-trained models to new equipment or fault types with minimal additional training data.
Active Learning: Techniques that intelligently select the most informative instances for expert labeling, optimizing the use of expert input in model refinement.
Bayesian Updating: Methods that update the prior probabilities of fault occurrences based on new evidence and maintenance outcomes.
Incremental Decision Trees: Algorithms like Hoeffding Trees that can update their structure and decision rules as new data becomes available.
Online Random Forests: Adaptations of random forest algorithms that can continuously update and grow trees based on streaming data.
Adaptive Resonance Theory (ART) Networks: Self-organizing neural networks that can create new categories for novel fault patterns while preserving existing knowledge.
Evolutionary Algorithms: Techniques that evolve and optimize fault detection models over time based on their performance in real-world scenarios.

These adaptive learning algorithms may be used in combination and may be tailored to the specific characteristics of the equipment and the nature of the feedback received. The process 600 may dynamically select and configure these algorithms to optimize their effectiveness in refining fault detection models over time.

The orchestrator 105 can make predictions and recommendations to prevent failures before they occur. The orchestrator 105 makes predictions and recommendations to prevent failures before they occur by employing prognostic algorithms that analyze the current state of the equipment and its historical performance data. In some aspects, the orchestrator 105 may use machine learning techniques to build predictive models that estimate the remaining useful life of equipment components and systems. These models take into account the trends and patterns of wear and tear, as well as the operational conditions under which the equipment is used.

The process 600 may employ various machine learning techniques to build predictive models that estimate the remaining useful life of equipment components and systems. These techniques may include, without limitation:
Recurrent Neural Networks (RNNs): Particularly Long Short-Term Memory (LSTM) and Gated Recurrent Unit (GRU) networks, which are effective for modeling sequential data and capturing long-term dependencies in time series.
Survival Analysis Models: Techniques such as Cox Proportional Hazards models and Accelerated Failure Time models, which are specifically designed to estimate time-to-event outcomes.
Random Forest Regression: An ensemble learning method that can handle non-linear relationships and is robust to overfitting, making it suitable for predicting remaining useful life.
Gradient Boosting Machines: Algorithms like XGBoost and LightGBM, which can capture complex interactions between features and provide accurate predictions of equipment lifespan.
Support Vector Regression (SVR): A technique that can effectively model non-linear relationships and is particularly useful when dealing with high-dimensional feature spaces.
Gaussian Process Regression: A probabilistic approach that provides uncertainty estimates along with predictions, which is valuable for risk assessment in remaining useful life estimation.
Deep Neural Networks: Multi-layer perceptron architectures that can learn complex patterns from large datasets of historical equipment performance.
Ensemble Methods: Combining multiple models, such as bagging and boosting techniques, to improve prediction accuracy and robustness.
Transfer Learning: Leveraging pre-trained models on similar equipment to improve predictions on new or data-scarce equipment types.
Bayesian Neural Networks: Providing probabilistic predictions of remaining useful life, which can be crucial for decision-making in maintenance planning.

These techniques may be used in combination and may be tailored to the specific characteristics of the equipment and the available data. The process 600 may also employ feature engineering and selection methods to identify the most relevant indicators of equipment degradation and improve the accuracy of the predictive models.

Some embodiments also employ the use of a digital twin. As used herein, a “digital twin” is a simulated representation of a hardware asset. The digital twin is configured to operate in the same manner as the hardware asset, but in a simulated manner. Optionally, prior to generating the alert 650 and the work order 655, the orchestrator 105 can test the proposed resolution using the digital twin, as shown by LLM digital twin test 670. Based on this test, the orchestrator 105 can make a better prediction 675 as to whether the proposed resolution will or will not be successful. Any number of testing iterations can be performed using any number of alternative proposed solutions. This testing might involve modification of configuration parameters, asset state, and potentially environmental conditions. All these modifications can be simulated and tested using the digital twin and the orchestrator 105.

When solutions are found to a given anomaly, the data model 605 can be updated to include these solutions for the anomalies. Thus, iterative and continuous learning and improvement can be achieved via the disclosed embodiments.

Thus, the orchestrator 105 is able to detect one or more anomalies for an asset. Optionally, these anomalies can be detected via the use of a trained artificial neural network (ANN) that is trained to detect anomalies in an asset's behavior. When an anomaly is detected, the orchestrator 105 can determine a source for the anomaly. The orchestrator 105 can then attempt to block, impede, or otherwise interact with the source in an attempt to eliminate the anomalous behavior. As one example, if the anomaly is determined to arise due to a change in an environmental condition, the orchestrator 105 can communicate with an Internet of Things (IOT) climate control device to modify the climate in which the asset is operating. The orchestrator 105 can instruct the IoT climate control device to change one or more conditions in an attempt to eliminate the anomalous behavior for the asset. Stated differently, in some scenarios, orchestrator 105 communicates with an IoT device that controls a condition associated with an asset, and controlling the condition associated with that asset results in a modification to a performance of the asset. The orchestrator 105 can communicate with a system or human to make adjustments to remove the anomaly. The orchestrator 105 can also communicate with a PLC to control various aspects or features of the asset in an attempt to remove the anomaly.

As used herein, the phrase IoT generally refers to one or more networked physical devices that are embedded with controls, sensors, software, and network connectivity. These IoT devices communicate over the Internet. The IoT devices can be used to collect information from assets and other physical world conditions and transmit that information to an end destination. In some scenarios, the IoT devices include logic structured to enable control of an asset, such as a climate control device. Instructions can be sent to the IoT device to control the asset. Thus, remote control, monitoring, and automation can be implemented via the use of IoT devices.

The process 600 handles false positives or negatives in fault detection by incorporating multiple layers of validation and verification processes. In some aspects, the process 600 may use a combination of threshold-based checks, historical data comparisons, and consensus mechanisms among various sensor inputs to reduce the likelihood of incorrect fault detection. The process 600 may also employ adaptive learning algorithms that continuously refine the fault detection models based on feedback from maintenance outcomes and expert input, allowing the system to improve its accuracy over time. Additionally, the process 600 can be configured to rely on confirmation for ambiguous cases or when the predicted impact of a potential fault is particularly high, ensuring that decisions are made with due consideration. By using these methods, the system aims to minimize the occurrence of false positives, which could lead to unnecessary maintenance actions, and false negatives, which could result in missed opportunities for preventive intervention.

The performance in terms of accuracy, speed, and reliability in fault detection and prevention is characterized by its ability to correctly identify potential issues with a high degree of precision, minimizing false positives and negatives. In some aspects, the system may provide real-time monitoring and rapid analysis of sensor data, enabling timely detection of faults. The reliability of the process 600 is enhanced through robust algorithms and redundant sensor configurations that ensure consistent performance even in challenging industrial environments. The predictive capabilities are continuously improved through machine learning, which applies insights from historical data to refine fault detection accuracy over time.

In various embodiments, the process 600 incorporates various validation and verification processes to handle false positives or negatives in fault detection. These processes may include, without limitation:
Multi-sensor Data Fusion: Combining data from multiple sensors to cross-validate fault detections, reducing the likelihood of false positives or negatives from a single sensor.
Statistical Hypothesis Testing: Applying rigorous statistical tests to evaluate the significance of detected anomalies, helping to distinguish between genuine faults and random fluctuations.
Confidence Scoring: Assigning confidence scores to fault detections based on the strength and consistency of the evidence, allowing for prioritization of high-confidence detections.
Historical Data Comparison: Validating detected faults against historical patterns and known fault signatures to ensure consistency with previously observed equipment behavior.
Expert System Rules: Implementing a set of expert-defined rules to validate fault detections against domain knowledge and known equipment characteristics.
Machine Learning-based Anomaly Validation: Utilizing supervised or semi-supervised machine learning models trained on labeled fault data to validate and classify detected anomalies.
Time-series Analysis: Employing techniques such as change point detection and trend analysis to verify the persistence and progression of detected faults over time.
Fault Tree Analysis: Using logical diagrams to validate the sequence of events leading to a detected fault, ensuring the fault's consistency with known failure modes.
Simulation-based Verification: Comparing detected faults against simulated equipment behavior to verify their plausibility under given operating conditions.
Human-in-the-loop Verification: Incorporating expert review and feedback for ambiguous or high-impact fault detections, allowing for manual validation when necessary.

These processes may be used in combination and may be adaptively applied based on the criticality of the equipment and the potential impact of false detections. The process 600 may employ continuous learning techniques to refine these validation processes over time, improving their accuracy and effectiveness in handling false positives and negatives.

FIG. 7 shows an example of forecasting process flow 700. The process flow can be performed by orchestrator 105 (in cooperation with agents 150) using the data pool 140. Each of the components are like their counterparts in FIG. 6 unless otherwise described herein.

The data model 605, which corresponds to the data pool 140, is accessed by the orchestrator 105, e.g., via an API. Here, the data model 605 includes past orders 710 (e.g., previous work orders) for a given asset as well as past usage 715 metrics for the asset. Using the data model 605, the orchestrator 105 generates a forecast 720 regarding a future state for the asset. For instance, the forecast 720 can include a determination that a certain part will likely fail by a given predicted date and that the part should be replaced prior to that date. The forecast 720 can include a determination that certain inventory may be depleted by a given predicted date, and additional inventory should be ordered prior to the depletion date. The forecast 720 can include any prediction regarding the asset.

The orchestrator 105 can trigger the generation of a work order 725 based on the given forecast 720. The orchestrator 105 can include the work order 725 in project management, thereby allowing for the asset's workflow management 730 to be properly managed.

The orchestrator 105 can also identify one or more alternative options 735 with respect to a given part or inventory item that is to be replaced or replenished. For instance, during the time of manufacture, assets are typically equipped with OEM parts. Non-OEM parts might be made for the asset, and it might be the case that the non-OEM parts are cheaper or perhaps even more durable than the OEM parts. The orchestrator 105 can determine that these non-OEM parts or inventory are viable alternative options 735 for the OEM parts or inventory. The alternative options 735 can be included in the data model 605.

In this manner, the orchestrator 105 (e.g., via an API) can implement a parts classifier that identifies parts usage across any number of organizations, parts information from documentation, and labelled parts data to classify/cluster into parts groups. The orchestrator 105 is able to define parts that are similar/cross-functional. The orchestrator 105 can recommend parts based on parts usage within an organization. The orchestrator 105 beneficially provides options for replacement parts that fit the asset usage and maintenance schedule.

The orchestrator 105 can use documentation information extracted from manuals and history of parts usage from an organization to predict actionable next steps within the system (e.g., purchase order for predicted parts amount, potential assignment of purchase order, maintenance work order, etc.). The orchestrator 105 can use sensor data triggers as well as maintenance and work order histories in order to proactively create work and purchase orders.

In some scenarios, the orchestrator 105 can manage various inventory records for an asset by tracking the location of items of inventory in a warehouse for the asset. Optionally, different camera systems (e.g., high resolution cameras) can be used, including an array of multiple cameras. Each camera may be positioned at a pre-determined location in the warehouse. Optionally, some of the fields of view of the cameras can at least partially overlap. These cameras are able to obtain image sequences of each item of inventory in the warehouse.

The orchestrator 105 can optionally create an inventory record for the items in inventory. This inventory record can optionally include the acquired image sequence from the camera array. The orchestrator 105 can add classification data to the image, where the classification data may specifically state a given image reflects a specific type of inventory. Optionally, image analysis can be performed on the image to determine quantity of the inventory, as represented in the image. Location data can also be added to the image. Optionally, three-dimensional (3D) coordinates for the inventory can also be reconstructed. For instance, it might be the case that the inventory is on the fifth shelf, so the 3D coordinates can include height data as well as X-Y data relative to the floor. The orchestrator 105 can automatically update the inventory record to include the 3D coordinates for the inventory. Stated differently, the orchestrator 105 can automatically update the inventory record to include the physical location of the item within the warehouse. This information can be used during the forecasting operations.

FIG. 8 shows an example of an optimization process flow 800. The process flow can be performed by orchestrator 105 (in cooperation with agents 150) using the data pool 140. Each of the components are like their counterparts in FIG. 6 unless otherwise described herein.

The data model 605, which corresponds to the data pool 140, is accessed by the orchestrator 105, e.g., via an API. The data model 605 is shown as including global repository 630 such as sensor data for a given asset. The global repository 630 includes data from other clients for the same make and model (or within a threshold similarity) of the asset currently being analyzed by the orchestrator 105.

The orchestrator 105 is able to use the data model 605 to generate an operational change 820 that, if employed, may result in an increased life span of the given asset and/or may result in improved performance of the asset without sacrificing lifespan. Specifically, the orchestrator 105 is able to identify behavioral trends 825 for the asset based on the instant asset's own data as well as other data obtained from other instances of that asset.

After generating the operational change 820, the orchestrator 105 can facilitate digital twin testing 830 by testing the operational change 820 using the asset's digital twin. The digital twin testing 830 may result in an indication that the proposed operational change 820 is a viable option for prolonging the asset's lifespan and/or for increasing an efficiency or output of the asset without sacrificing the asset's lifespan. Optionally, in some scenarios, the orchestrator 105 is implemented or can operate as the digital twin. Stated differently, the orchestrator 105 can be configured as the digital twin disclosed herein. Thus, in some scenarios, the orchestrator 105 and the digital twin are separate entities while in other scenarios, the orchestrator 105 and the digital twin are the same entity. To illustrate, an asset-specific LLM-based system can operate as a digital twin if the LLM system is continuously updated with sensor data and maintains live access to asset status and recent work history (as well as integrating with predictive models and other tools).

By continuously updating the disclosed data models with new data, the orchestrator 105 can provide dynamic predictions that reflect the current health of the equipment. It should be noted how the updating process can include continuous updating techniques, such as continuous learning, fine-tuning, and/or reinforcement learning techniques. When the orchestrator 105 anticipates a potential failure, it generates recommendations for maintenance actions that can be taken to mitigate the risk. These recommendations may include specific repairs, adjustments, or replacements that are likely to prevent the failure from occurring. The orchestrator 105 may also suggest changes to the operational parameters of the equipment to reduce stress and wear, thereby extending its lifespan. Additionally, the orchestrator 105 can schedule these maintenance activities at times that minimize disruption to the production process, further enhancing the efficiency and reliability of the industrial operation.

As an example, it may be the case that the user manual indicates that the asset should not operate beyond a threshold level of performance or the asset may be harmed. In practice, however, it may be found that the threshold level is overly conservative and no actual harm occurs if the asset performs beyond that threshold. Thus, the asset can actually operate at a higher level of performance than the one indicated in the user manual. This determination can be made based on performance data acquired from the instant asset as well as other client's assets of the same type. Technicians may provide feedback data to indicate the potential for increased output without loss of lifespan. Any type of feedback can be employed and can be provided to the orchestrator 105 and the data pool 140.

After generating the operational change 820 and potentially after performing the digital twin testing 830 to validate the operational change 820, the orchestrator 105 can generate a work order 835 that, when implemented, modifies the performance of the asset. This modification is designed to increase the life span of the asset, as shown by increased life span 840, and/or increase the output or efficiency of the asset without compromising the lifespan at all or beyond an acceptable threshold level of compromise. The modification may result in changes to configuration parameters of the asset, scheduling of the asset, uptime and downtime changes for the asset, power up and power down events for the asset, and so on.

The process 800 extends the lifetime of the equipment and reduces costs by implementing a proactive maintenance strategy based on the predictive insights generated from the analyzed data. In some aspects, the recommendations for maintenance actions are designed to address issues before they escalate into major failures, thus avoiding the higher costs associated with emergency repairs and equipment downtime. By scheduling regular maintenance based on the equipment's actual condition rather than on a fixed schedule, the process 800 ensures that parts are serviced or replaced precisely when it is warranted, which can prevent unnecessary maintenance activities and associated expenses. Additionally, the ability to optimize operational parameters can lead to more efficient use of the equipment, reducing wear and tear and conserving energy, which further contributes to cost savings. Overall, the disclosed predictive maintenance approach leads to an increase in the reliability and availability of the equipment, which translates into a longer service life and a reduction in total cost of ownership.

As one example, actual usage data might indicate that an asset performs better if it is not power cycled on and off; instead, the asset operates better when the asset is allowed to stay powered on indefinitely. The user manual, on the other hand, may state otherwise. The orchestrator 105 can use this actual performance data to suggest a modification in the asset's behavior, where that modification actually results in an improvement to the performance of the asset even though the modification is contrary to the OEM recommendation.

In various embodiments, the system has native support for industrial communication protocols (e.g., Modbus, OPC UA, or MQTT), or may communicate via low-level interfaces such as TCP/UDP socket connections when supported by the asset. Alternatively, the orchestrator may interface with a PLC. In another scenario, the orchestrator 105 can communicate directly with the asset and/or with a PLC that controls the asset. Via this communication interface, the orchestrator 105 can modify the performance of the asset in accordance with the projected modification that is designed to optimize the asset, such as by extending its lifespan or by increasing its efficiency without significantly (e.g., exceeding a threshold amount) impairing its lifespan. Thus, actual performance changes to the asset can be implemented by the orchestrator 105.

FIG. 9 is a flow diagram illustrating an embodiment of a process for assembling a data pool according to a unified data acquisition framework. This process may be implemented on interface 135 of FIG. 1. This process may be performed as part of another process such as part of 200 of FIG. 2A or after 200 of FIG. 2A. An example of a data pool assembled in this manner is data pool 140 of FIG. 1. This process is an example of assembling a data pool according to a unified data acquisition framework.

The process integrates a more comprehensive array of sensor data, including not just external sensor readings but also internal operational data from the equipment's control systems, such as the PLC. This holistic approach allows for a more nuanced understanding of the equipment's condition and performance. The process handles data from different types of sensors, such as vibration sensors, temperature sensors, current sensors, etc., by implementing a unified data acquisition framework that standardizes the collection, transmission, and processing of sensor data.

The process begins by collecting data from at least one sensor based at least in part on defined data standards (900).

The process normalizes the collected data (902). The system normalizes the data to account for variations in sensor types, measurement scales, and data formats. This normalization process allows for the comparison and combination of data from different sensors to provide a comprehensive picture of the equipment's health.

The process integrates the normalized data (904). In various embodiments, the system uses sensor fusion techniques to integrate data from heterogeneous sensors, ensuring that the information is coherent and can be analyzed in a unified manner.

Conventional techniques for equipment monitoring typically do not synthesize data from disparate sources in this way. The disclosed techniques for assembling a data pool according to a unified data acquisition framework improve the data that is analyzed, e.g., by an orchestrator or downstream agents. Consequently, the orchestrator outputs a more accurate prediction in a more efficient manner.

The disclosed agents 110, 115, and 120 (collectively referred to as agents 150) may be trained with a training data set that is improved compared with conventional training data. One challenge for assembling training data is the “cold start” problem, which refers to the challenge of making accurate predictions, recommendations, or decisions when little or no historical data is available for training the agent. An improved training data set may be created by injecting data representative of equipment failure in the training data. In other words, at least one of the first agent 110 and the second agent 115 is trained using a training data set; and the training data set includes synthetic data associated with a fault in the equipment.

FIG. 10 is a diagram illustrating an example of an environment in which equipment failure may be detected and prevented using operational data. The environment in this example is a warehouse 1000 that includes a first asset 1005 and a second asset 1010. Of course, any number of assets can be involved in the disclosed principles. FIG. 10 also shows various sensors, such as sensor 1015 and sensor 1020. The cameras (e.g., camera 1025 and camera 1030) are also considered sensors. The sensors are generating sensor data 1035. This sensor data 1035 may be generated at a location that is remote relative to where the orchestrator 105 of FIG. 1 is disposed or the sensor data 1035 may be generated at the same location where orchestrator 105 is located. If remote, then the sensor data 1035 can be transmitted over one or more networks to the orchestrator 105.

The sensor data 1035 may be of any type. Example types of the sensor data 1035 include, but are not limited to, numerical data, alphanumeric data, text data, image data, video data, depth data, spectral analysis data, pressure data, temperature data, flow data, speed data, and so on.

The embodiments can be utilized in a wide range of industrial sectors where machinery and equipment are used. For instance, in the manufacturing industry, the disclosed system can be integrated into the production line to monitor the health of machines and prevent unexpected breakdowns, thereby improving efficiency and reducing downtime.

The disclosed embodiments find application in a variety of environments such as those involving a variety of industrial equipment including, but not limited to, motors, pumps, compressors, turbines, fans, blowers, gearboxes, conveyors, and CNC machines. It may also be applicable to robotic arms, automated guided vehicles (AGVs), and other automated machinery used in manufacturing and processing industries.

The disclosed techniques may, without limitation:
identify an anomaly of the first or second asset based, at least in part, on a first performance trend,
forecast when a part of the first or second asset is due for replacement,
identify an alternative replacement part for the first or second asset, where the alternative replacement part is an alternative for an original equipment manufacturer (OEM) part for the asset, or
modify a performance of the first or second asset based on a determination that the modification will result in a prolonging of a lifespan of the first or second asset.

The system of FIG. 1 integrates with the production line in the manufacturing industry such as the environment shown in FIG. 10 by interfacing with existing manufacturing execution systems (MES) and other industrial automation systems. In some aspects, the system 100 may be configured to communicate with the warehouse 1000 using standard industrial protocols, allowing it to receive and send data in real-time. This integration enables the system 100 to access operational data directly from the machines (such as asset 1005 and asset 1010) on the production line and to provide feedback that can be used to adjust processes and operations. Additionally, the sensors and data collection modules of system 100 can be installed on the production equipment without disrupting existing workflows. The software components of system 100 can be deployed on local servers or in the cloud, providing flexibility in data processing and storage. By integrating seamlessly with the production line, the system 100 can monitor the health of the equipment continuously and provide actionable insights to optimize manufacturing processes and prevent unplanned downtime.

FIG. 11 is a functional diagram illustrating a programmed computer system for detecting and preventing equipment failure using operational data in accordance with some embodiments. As will be apparent, other computer system architectures and configurations can be used to detect and prevent equipment failure using operational data. Computer system 1100, which includes various subsystems as described below, includes at least one microprocessor subsystem (also referred to as a processor or a central processing unit (CPU)) 1102. For example, processor 1102 can be implemented by a single-chip processor or by multiple processors. In some embodiments, processor 1102 is a general purpose digital processor that controls the operation of the computer system 1100. Using instructions retrieved from memory 1110, the processor 1102 controls the reception and manipulation of input data, and the output and display of data on output devices (e.g., display 1118). In some embodiments, processor 1102 includes and/or is used to provide orchestrator 105 of FIG. 1 and/or executes/performs the processes described with respect to FIGS. 2, 8, and 9.

Processor 1102 is coupled bi-directionally with memory 1110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1102. Also as is well known in the art, primary storage typically includes basic operating instructions, program code, data and objects used by the processor 1102 to perform its functions (e.g., programmed instructions). For example, memory 1110 can include any suitable computer-readable storage media, described below, depending on whether, for example, data access needs to be bi-directional or uni-directional. For example, processor 1102 can also directly and very rapidly retrieve and store frequently needed data in a cache memory (not shown).

A removable mass storage device 1112 provides additional data storage capacity for the computer system 1100, and is coupled either bi-directionally (read/write) or uni-directionally (read only) to processor 1102. For example, storage 1112 can also include computer-readable media such as magnetic tape, flash memory, PC-CARDS, portable mass storage devices, holographic storage devices, and other storage devices. A fixed mass storage 1120 can also, for example, provide additional data storage capacity. The most common example of mass storage 1120 is a hard disk drive. Mass storages 1112, 1120 generally store additional programming instructions, data, and the like that typically are not in active use by the processor 1102. It will be appreciated that the information retained within mass storages 1112 and 1120 can be incorporated, if needed, in standard fashion as part of memory 1110 (e.g., RAM) as virtual memory.

In addition to providing processor 1102 access to storage subsystems, bus 1114 can also be used to provide access to other subsystems and devices. As shown, these can include a display monitor 1118, a network interface 1116, a keyboard 1104, and a pointing device 1106, as well as an auxiliary input/output device interface, a sound card, speakers, and other subsystems as needed. For example, the pointing device 1106 can be a mouse, stylus, track ball, or tablet, and is useful for interacting with a graphical user interface.

The network interface 1116 allows processor 1102 to be coupled to another computer, computer network, or telecommunications network using a network connection as shown. For example, through the network interface 1116, the processor 1102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1102 can be used to connect the computer system 1100 to an external network and transfer data according to standard protocols. For example, various process embodiments disclosed herein can be executed on processor 1102, or can be performed across a network such as the Internet, intranet networks, or local area networks, in conjunction with a remote processor that shares a portion of the processing. Additional mass storage devices (not shown) can also be connected to processor 1102 through network interface 1116.

An auxiliary I/O device interface (not shown) can be used in conjunction with computer system 1100. The auxiliary I/O device interface can include general and customized interfaces that allow the processor 1102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 11 is but an example of a computer system suitable for use with the various embodiments disclosed herein. Other computer systems suitable for such use can include additional or fewer subsystems. In addition, bus 1114 is illustrative of any interconnection scheme serving to link the subsystems. Other computer architectures having different configurations of subsystems can also be utilized.

The disclosed techniques find application in a variety of settings to more efficiently and effectively monitor equipment. A practical application of the process of FIGS. 2A and 2B is a modification that is made to equipment, such as the equipment shown in the environment of FIG. 4

The disclosed techniques also improve the technical field of AI/ML models (agents) because agents can perform better (make better predictions and evaluations). The disclosed orchestrator and agent system does not rely on the limitation of a single agent. Instead, the orchestrator can combine the assessments of multiple agents to improve the confidence of an evaluation or to obtain a better result. The disclosed training data assembly techniques also improve the training set provided to the agent, which improves the predictions made by the agent. The technological systems associated with the disclosed techniques inherently have limited computing resources because the capabilities of agents are finite. The disclosed techniques efficiently utilize the available computing resources. For example, the agents ingest limited data, but the available data sets are large. For example, sensor and operational data may extend for a long period of time. The disclosed techniques for synthesizing and processing of the data sets improve the functioning of the agents by standardizing and extracting the most useful data.

The disclosed techniques are uniquely performed by a computer system and are not capable of being performed by the human mind. In one aspect, the agents access a shared data pool. The agents can commonly access a shared data pool, which humans are typically unable to do even with the best documentation due to communication errors, etc. Humans are unable to generalize to the level of accuracy disclosed because it is beyond human capacity. For example, the orchestrator can extract the most relevant work executed on a given asset, the most similar asset(s), the most probable spikes or patterns in the sensor data, etc. Moreover, the real-time processing and high volume of data processed exceed the capabilities of a human. For example, instead of waiting for a vibration analyst to visit a work-site every 3 months, the disclosed automatic analysis techniques may be performed in parallel for all equipment to efficiently and accurately provide an assessment and recommendations with respect to the equipment.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for maintaining equipment, comprising:
an interface configured to receive information about a state of the equipment from a plurality of sources;
a data pool including the information from the interface;
a plurality of agents configured to access data in the data pool, wherein the plurality of agents are trained to assess a condition of the equipment based on the data; and
an orchestrator configured to:
evaluate an assessment of a first agent;
in response to the evaluation of the assessment of the first agent indicating access of a second agent, access the second agent for further assessment; and
cause a modification to be made to the equipment.

2. The system of claim 1, wherein the plurality of sources includes a programmable logic controller (PLC).

3. The system of claim 1, wherein the information from the interface includes at least one of: historical information and a maintenance history.

4. The system of claim 1, wherein the information from the interface includes a configuration.

5. The system of claim 1, wherein the information from the interface includes information associated with another equipment within a threshold similarity of the equipment.

6. The system of claim 1, wherein the information from the interface includes data collected by a technician.

7. The system of claim 1, further comprising a sensor, wherein the modification made to the equipment includes turning on the sensor.

8. The system of claim 1, wherein the assessment of the first agent includes an indication to acquire additional data to improve confidence.

9. The system of claim 1, wherein the assessment of the first agent includes adding a sensor.

10. The system of claim 1, wherein the orchestrator is configured to detect an anomaly associated with the equipment based at least in part on digital signal processing (DSP).

11. The system of claim 1, wherein the orchestrator is further configured to output a maintenance recommendation.

12. The system of claim 1, wherein the orchestrator is further configured to output at least one of: a prediction or request for more information.

13. The system of claim 1, wherein the orchestrator is further configured to determine a generalization across at least one of: assets within a threshold similarity of each other and a plurality of instances of assets.

14. The system of claim 1, wherein:
at least one of the first agent and the second agent is trained using a training data set; and
the training data set includes synthetic data associated with a fault in the equipment.

15. The system of claim 1, wherein:
at least one parameter is extracted from the received information about the state of the equipment; and
the at least one parameter includes at least one of: electrical current, temperature, vibration frequency, and vibration amplitude.

16. The system of claim 1, wherein the data pool is assembled according to a unified data acquisition framework including by:
collecting data from at least one sensor based at least in part on defined data standards;
normalizing the collected data; and
integrating the normalized data.

17. A method, comprising:
receiving information about a state of the equipment from a plurality of sources;
accessing data in a data pool, wherein:
the plurality of agents are trained to assess a condition of the equipment based on the data; and
the data pool includes information from an interface;
evaluating an assessment of a first agent;
in response to the evaluation of the assessment of the first agent indicating access of a second agent, accessing the second agent for further assessment; and
causing a modification to be made to the equipment.

18. A computer program product embodied in a non-transitory computer readable medium and comprising computer instructions for:
receiving information about a state of the equipment from a plurality of sources;
accessing data in a data pool, wherein:
the plurality of agents are trained to assess a condition of the equipment based on the data; and
the data pool includes information from an interface;
evaluating an assessment of a first agent;
in response to the evaluation of the assessment of the first agent indicating access of a second agent, accessing the second agent for further assessment; and
causing a modification to be made to the equipment.

19. A system for maintaining equipment, comprising:
an interface configured to receive information about a state of the equipment from a plurality of sources;
a data pool including the information from the interface;
a plurality of agents configured to access data in the data pool, wherein the plurality of agents are trained to assess a condition of the equipment based on the data; and
an orchestrator configured to:
obtain a task plan;
evaluate an output of a first agent;
determine a next action to take based at least in part on the output of the first agent;
perform the next action; and
in response to meeting a stopping condition of the task plan, cause a modification to be made to the equipment.

20. The system of claim 19, wherein the next action includes accessing a second agent.
